(19) United States
(12) Patent Application Publication
(10) Pub. No.: US 2021/0207246 A1
(43) Pub. Date: Jul. 8, 2021

(54) LEAD-FREE AND COPPER-FREE TIN ALLOY AND SOLDER BALL FOR BALL GRID ARRAY PACKAGE

(71) Applicant: SHENMAO TECHNOLOGY INC., Taoyuan City (TW)

(72) Inventors: Chun-yu CHANG, Taoyuan City (TW); Chih-Hsiang LI, Taoyuan City (TW); Boon-Ho LEE, Taoyuan City (TW)

(21) Appl. No.: 16/841,162

(22) Filed: Apr. 6, 2020

(30) Foreign Application Priority Data
Jan. 6, 2020 (TW) 109100379

(51) Int. Cl. C22C 13/00; B23K 35/02; B23K 35/26

(52) U.S. Cl. CPC C22C 13/00; B23K 2101/40; B23K 35/262; B23K 35/0244

(57) ABSTRACT

A lead-free and copper-free tin alloy has 3.0-5.0 wt % (weight percentage) silver, 0.01-3.5 wt % bismuth, 0.01-3.5 wt % antimony, 0.005-0.1 wt % nickel, 0.005-0.02 wt % germanium and tin of a residual weight percentage. The lead-free and copper-free tin alloy can be used to manufacture solder ball for a ball grid array package, and the solder bump formed by the solder ball can withstand the thermal stress caused by the temperature change of the electronic component itself or the environment, and has the ability to withstand high mechanical shocks at the same time.

### TECHNICAL FIELD

The present disclosure relates to a tin alloy and a solder ball for a ball grid array made of the tin alloy, and in particular to, a lead-free and copper-free tin alloy and a solder ball for a ball grid array package, which is made of the lead-free and copper-free tin alloy.

### RELATED ART

With the increase in the number of inputs/outputs (I/O) of semiconductor devices, the packaging technology has evolved from a wire bonding package that could only be packaged using the periphery of the chip to a ball grid array package that have been packaged using the bottom surface of the chip. The technology is to redistribute IC pads (an I/O distribution) on a semiconductor component, wherein the IC pads are distributed on the bottom of a semiconductor component to increase the I/O density.

The conduction manners of the ball grid array package can be divided into metal bumps, conductive adhesives, and conductive films, wherein the solder bumps are mainly used metal bump technology. The ball grid array packages can be divided into non-wafer-level packages and wafer-level packages.

The non-wafer-level package means that after a silicon chip is soldered to an organic substrate by wire bonding or a flip chip manner, an underfill is poured between the silicon chip and the organic substrate, and then, another end of the organic substrate is soldered with a solder ball to form a solder bump, so as to form an electronic component. The electronic component will be soldered to the circuit board in a subsequent process to form an assembled circuit board. The difference between the thermal expansion coefficients of the silicon chip, the organic substrate and the circuit board is too large. Thus, when the temperature of the assembled circuit board itself or the environment changes, since there is a mismatch in the thermal expansion coefficients, the thermal stress caused by the mismatch may cause solder bump between the electronic component and the circuit board to be damaged, and the solder joint between the organic substrate and the silicon chip is usually not damaged due to the underfill.

The wafer-level package means that after most or all of the packaging and testing procedures are directly performed on a silicon wafer, the silicon wafer is cut to form a plurality of chips, a redistribution of pads of an integrated chip (IC) is performed on the chip directly without via the organic substrate, and then the solder balls are soldered to form solder bumps. Since the size of the packaged chip is almost the same as that of the bare chip, it is called a wafer level chip scale package (WLCSP). However, because the difference between the expansion coefficients of the silicon chip and the circuit board is too large, the solder bump as a connection between the silicon chip and the circuit board must be able to withstand the thermal stress caused by the temperature change of the electronic component itself or the environment. Further, the wafer-level packages are mostly used in mobile devices that are short, small, thin, and light, so the solder bumps must also be able to withstand high mechanical shock.

Therefore, how to find a tin alloy that can be used to make a solder ball for the ball grid array (BGA) package and the solder bump produced by the solder ball which can withstand the thermal stress caused by the temperature change of the electronic component itself or the environment and the high mechanical shock, has become an goal of current research.

### SUMMARY

According to an objective of the present disclosure, a lead-free and copper-free tin alloy is provided. The lead-free and copper-free tin alloy can be used to manufacture solder ball for a ball grid array package, and the solder bump formed by the solder ball can withstand the thermal stress caused by the temperature change of the electronic component itself or the environment, and has the ability to withstand high mechanical shocks at the same time.

The lead-free and copper-free tin alloy provided by the present disclosure has a total weight percentage of 100 wt %, and comprises 3.0-5.0 wt % silver, 0.01-3.5 wt % bismuth, 0.01-3.5 wt % antimony, 0.005-0.1 wt % nickel, 0.005-0.02 wt % germanium and tin of a residual weight percentage.

Another one objective of the present disclosure is to provide a solder ball for a ball grid array package. The solder bump formed by the solder ball can withstand the thermal stress caused by the temperature change of the electronic component itself or the environment, and has the ability to withstand high mechanical shocks at the same time.

The solder ball for the ball grid array package provided by the present disclosure is made of the above lead-free and copper-free tin alloy.

Since the lead-free and copper-free tin alloy comprises 3.0-5.0 wt % silver, 0.01-3.5 wt % bismuth, 0.01-3.5 wt % antimony, 0.005-0.1 wt % nickel, 0.005-0.02 wt % germanium and tin of a residual weight percentage, and the solder ball is made of the lead-free and copper-free tin alloy of the present disclosure, the solder bump formed by the solder ball can withstand the thermal stress caused by the temperature change of the electronic component itself or the environment, and has the ability to withstand high mechanical shocks at the same time.

The details of the present disclosure are illustrated as follows.

The lead-free and copper-free tin alloy provided by the present disclosure has a total weight percentage of 100 wt %, and comprises 3.0-5.0 wt % silver, 0.01-3.5 wt % bismuth, 0.01-3.5 wt % antimony, 0.005-0.1 wt % nickel, 0.005-0.02 wt % germanium and tin of a residual weight percentage.

It is noted that, the lead-free and copper-free tin alloy substantially does not comprise the lead (Pb) and the copper (Cu), and this means when manufacturing the tin alloy, the lead and the copper are not intended to be added in the tin alloy, but the lead and the copper may be still included in the tin alloy with little percentages due to the unintended and inevitable contacts or impurities. However, such tin alloy in the present disclosure substantially does not comprise the lead and the copper, or the tin alloy is the lead-free and copper-free. The term “wt %” is the weight percentage, and the value range in the present disclosure always comprises two end values (upper limit and lower limit).

Further, to avoid misunderstanding, the term “the tin of the residual weight percentage” does not exclude from the case of the unintended and inevitable impurities during manufacturing. That is, if the impurities exist, the tin of the residual weight percentage is understood that the tin and the unintended and inevitable impurities are included in the lead-free and copper-free tin alloy of 100 wt %.

Preferably, the silver is 3.5-4.5 wt %; and more preferably, the silver is 3.75-4.25 wt %.

Preferably, the bismuth is 2.5-3.5 wt %; and more preferably, the bismuth is 2.75-3.25 wt %.

Preferably, the antimony is 0.5-1.5 wt %; and more preferably, the antimony is 0.75-1.25 wt %.

Preferably, the nickel is 0.045-0.055 wt %; and more preferably, the nickel is 0.0475-0.0525 wt %.

Preferably, the germanium is 0.005-0.015 wt %; and more preferably, the germanium is 0.0075-0.0125 wt %.

### BRIEF DESCRIPTIONS OF DRAWINGS

FIG. 1 is a photograph which illustrates a slice of a normal solder bump formed by embodiment 1.

FIG. 2 is a photograph which illustrates a slice of a defective solder bump formed by comparative example 9.

FIG. 3 is a photograph which illustrates an X-ray observation result of a defective solder bump formed by comparative example 9.

### DETAILED DESCRIPTION OF THE PREFERRED EMBODIMENTS

In order to facilitate the examiner to understand the technical features, the contents and the advantages of the present disclosure, as well as the efficacy that can be reached by the present disclosure, the present disclosure will now be described in detail with the drawings and the form of expression of the embodiments. The drawings used are only for illustration and support of the specification, and hence are not necessarily accurate in scale and precise in configuration after implementation of the present disclosure. Therefore, it should not be interpreted based upon the scale and the configuration on the drawings to confine the scope of the rights claimed on the practical implementation of the present disclosure.

### Embodiments 1-11 and Comparative Examples 1-10

Manufacturing of Lead-Free and Copper-Free Tin Alloy

lead-free and copper-free tin alloy of embodiments 1-11 and comparative examples 1-10 are obtained by the following steps and according to metal compositions and their wt % of Table 1:

step (1): according to metal compositions and their wt %, the corresponding metal materials are prepared.

step (2): the prepared metal materials are heated to be melted and casted to form the lead-free and copper-free tin alloy of embodiments 1-11 and comparative examples 1-10.

TABLE 1

| | wt % of metal composition | | | | | | test result in property | | | | | |
|---|---|---|---|---|---|---|---|---|---|---|---|---|
| | Sn | Ag | Bi | Sb | Ni | Ge | P1 | P2 | P3 | P4 | P5 | P6 |
| E1 | res. | 4.0 | 3.0 | 1.0 | 0.05 | 0.01 | ◯ | ◯ | ◯ | ◯ | ◯ | ◯ |
| E2 | res. | 3.0 | 3.0 | 1.0 | 0.05 | 0.01 | ◯ | Δ | ◯ | ◯ | ◯ | Δ |
| E3 | res. | 5.0 | 3.0 | 1.0 | 0.05 | 0.01 | Δ | ◯ | Δ | Δ | Δ | Δ |
| E4 | res. | 4.0 | 0.01 | 1.0 | 0.05 | 0.01 | ◯ | Δ | ◯ | Δ | ◯ | Δ |
| E5 | res. | 4.0 | 3.5 | 1.0 | 0.05 | 0.01 | ◯ | ◯ | Δ | ◯ | ◯ | Δ |
| E6 | res. | 4.0 | 3.0 | 0.01 | 0.05 | 0.01 | ◯ | Δ | ◯ | Δ | ◯ | Δ |
| E7 | res. | 4.0 | 3.0 | 3.50 | 0.05 | 0.01 | Δ | ◯ | Δ | ◯ | Δ | Δ |
| E8 | res. | 4.0 | 3.0 | 1.0 | 0.005 | 0.01 | ◯ | ◯ | ◯ | Δ | ◯ | Δ |
| E9 | res. | 4.0 | 3.0 | 1.0 | 0.1 | 0.01 | ◯ | ◯ | Δ | ◯ | ◯ | Δ |
| E10 | res. | 4.0 | 3.0 | 1.0 | 0.05 | 0.005 | ◯ | ◯ | ◯ | ◯ | Δ | Δ |
| E11 | res. | 4.0 | 3.0 | 1.0 | 0.05 | 0.02 | Δ | ◯ | ◯ | ◯ | ◯ | Δ |
| EX1 | res. | 2.0 | 3.0 | 1.0 | 0.05 | 0.01 | ◯ | X | ◯ | X | ◯ | X |
| EX2 | res. | 6.0 | 3.0 | 1.0 | 0.05 | 0.01 | X | ◯ | X | X | X | X |
| EX3 | res. | 4.0 | 0 | 1.0 | 0.05 | 0.01 | ◯ | X | ◯ | X | ◯ | X |
| EX4 | res. | 4.0 | 4.0 | 1.0 | 0.05 | 0.01 | ◯ | ◯ | X | Δ | ◯ | X |
| EX5 | res. | 4.0 | 3.0 | 0 | 0.05 | 0.01 | ◯ | X | ◯ | X | ◯ | X |
| EX6 | res. | 4.0 | 3.0 | 4.0 | 0.05 | 0.01 | X | ◯ | X | Δ | X | X |
| EX7 | res. | 4.0 | 3.0 | 1.0 | 0 | 0.01 | ◯ | ◯ | ◯ | X | ◯ | X |
| EX8 | res. | 4.0 | 3.0 | 1.0 | 0.2 | 0.01 | ◯ | ◯ | X | Δ | ◯ | X |
| EX9 | res. | 4.0 | 3.0 | 1.0 | 0.05 | 0 | ◯ | ◯ | ◯ | Δ | X | X |
| EX10 | res. | 4.0 | 3.0 | 1.0 | 0.05 | 0.05 | X | ◯ | ◯ | Δ | X | X |

It is noted that, the abbreviations of terms in tables of the present disclosure are stated as follows:
1. res. means “residual wt %”, which is a certain wt % and can be added with all of wt % of the other metal compositions for satisfying 100 wt % of the lead-free and copper-free tin alloy.
2. E1-E11 mean embodiments 1-11, and EX1-EX10 mean comparative examples 1-10.
3. P1-P6 respectively mean properties of ball shear, hardness, tensile, thermal cycle, board level soldering and overall assessment.

<Test of Alloy Property>

It is noted that, welding abilities, harness, alloy ductility properties, oxidization properties and resistances of solder joints and joint structures to thermal fatigue of the lead-free and copper-free tin alloy in embodiments 1-11 and comparative examples 1-10 are measured respectively by a ball shear test, a hardness test, a tensile test, a board level soldering test and a thermal cycle test.

The test manners of the ball shear test, the hardness test, the tensile test, the board level soldering test and the thermal cycle test are illustrated as follows.

[Ball Shear Test]

The JESD22-B117B standard test manner is used for the ball shear test of the lead-free and copper-free tin alloy in embodiments 1-11 and comparative examples 1-10. Firstly, BGA components with 14 mmx 14 mm sizes are coated with soldering flux, and the ball attach is performed, such that the solder balls with 0.45 mm diameters made of the lead-free and copper-free tin alloy in embodiments 1-11 and comparative examples 1-10 are attached on the BGA components. The pad surface of the BGA component is processed to be bare copper, and a reflow profile of 240° C. peak temperature is used to weld. The produced solder balls are welded on the BGA components to form the solder bumps, and then the ball shear tester is used to perform the ball shear test on the solder bumps (p.s. the speed of the moving knife is 100 μm/s).

In each alloy set of the BGA samples, 15 solder bumps are pushed and the ball shear strengths thereof are recorded. An average of the ball shear strengths of the 15 solder bumps is taken as an experiment result. The judging standard of the result is illustrated as follows: if the average of the ball shear strengths is larger than 15 Newton, the welding ability is judged to be good denoted with a mark “∘”; if the average of the ball shear strengths is 12-15 Newton, the welding ability is judged to be acceptable denoted with a mark “Δ”; and if the average of the ball shear strengths is less than 12 Newton, the welding ability is judged to be bad denoted with a mark “X”. The ball shear test results of the lead-free and copper-free tin alloy in embodiments 1-11 and comparative examples 1-10 are showed in Table 1.

[Hardness Test]

The ASTM-E92-17 standard test manner is used for the hardness test, the Vickers hardness tester is used to measure the hardness of the lead-free and copper-free tin alloy in embodiments 1-11 and comparative examples 1-10. Plate samples with 20 mm length, 20 mm widths and 10 mm lengths are made of the lead-free and copper-free tin alloy in embodiments 1-11 and comparative examples 1-10, the test surface of the plate samples are grinded and polished, and the standard test indenter of the Vickers hardness tester is used to perform indentation test on the plate samples (the indentation condition is 500 g load and 10 seconds load duration time). Next, the hardness of each alloy is calculated from the indentation size left by the plate sample.

In the hardness test of each alloy, hardness of three plate samples are tested, and the average hardness of the three plate samples are taken as the experiment result. The judge standard is illustrated as follows: if the average hardness is larger than 25 Hv, the hardness performance of the alloy is judged to be good denoted with a mark “∘”; if the average hardness is 22-25 Hv, the hardness performance of the alloy is judged to be acceptable denoted with a mark “Δ”; and if the average hardness is less than 22 Hv, the hardness performance of the alloy is judged to be bad denoted with a mark “X”. The hardness test results of the lead-free and copper-free tin alloy in embodiments 1-11 and comparative examples 1-10 are showed in Table 1.

[Tensile Test]

The ASTM-E8/E8M-16a standard test manner is used for the tensile test of the lead-free and copper-free tin alloy in embodiments 1-11 and comparative examples 1-10. The tensile speed is 6 mm/min, so as to compare the ductility rates of the all alloy via the elongation results of the tensile test.

In the tensile test of each alloy, elongation rates of three tensile samples are tested, and the average elongation rate of the three elongation samples are taken as the experiment result. The judge standard is illustrated as follows: if the average elongation rate is larger than 20%, the ductility of the alloy is judged to be good denoted with a mark “∘”; if the average elongation rate is 17-20%, the ductility of the alloy is judged to be acceptable denoted with a mark “Δ”; and if the average elongation rate is less than 17%, the ductility of the alloy is judged to be bad denoted with a mark “X”. The tensile test results of the lead-free and copper-free tin alloy in embodiments 1-11 and comparative examples 1-10 are showed in Table 1.

[Board Level Soldering Test]

Firstly, BGA components with 35 mm×35 mm sizes are coated with soldering flux, and the ball attach is performed, such that the solder balls with 0.63 mm diameters made of the lead-free and copper-free tin alloy in embodiments 1-11 and comparative examples 1-10 are attached on the BGA components. The pad surface of the BGA component is processed to be bare copper, and a reflow profile of 240° C. peak temperature is used to weld. The produced solder balls are welded on the BGA components to form the solder bumps, and then the samples are disposed in an environment with an 85° C. temperature and an 85% relative humidity for 240 hours, so as to accelerate the oxidization of the solder bumps. Then the BGA components are welded on the corresponding circuit boards, and the pad surfaces of the circuit board are processed to be organic solderability preservatives (OSPs). The test objective is to measure the oxidization resistances of the solder bumps on the BGA components formed by the solder balls which are made of the lead-free and copper-free tin alloy in embodiments 1-11 and comparative examples 1-10. The oxidization resistances of the alloy affect the welding properties which the solder bumps are welded to the circuit board. If the oxidization resistance of the alloy is not enough large, the welding property that the solder bump is welded to the circuit board is not good, and it causes the bad welding after the board level soldering process is processed.

The test is to analyze the bad welding rates via emitting X-ray to the board level soldering processed samples. The judge standard is illustrated as follows: if the bad welding rate is less than 10%, the board level soldering performance of the alloy is judged to be good denoted with a mark “∘”; if the bad welding rate is 10-20%, the board level soldering performance of the alloy is judged to be acceptable denoted with a mark “Δ”; and if the bad welding rate is larger than 20%, the board level soldering performance of the alloy is judged to be bad denoted with a mark “X”. The board level soldering test results of the lead-free and copper-free tin alloy in embodiments 1-11 and comparative examples 1-10 are showed in Table 1.

[Thermal Cycle Test]

The JESD22-A104E standard test manner is used for the thermal cycle test of the lead-free and copper-free tin alloy in embodiments 1-11 and comparative examples 1-10. Firstly, BGA components with 14 mmx 14 mm sizes are coated with soldering flux, and the ball attach is performed, such that the solder balls with 0.45 mm diameters made of the lead-free and copper-free tin alloy in embodiments 1-11 and comparative examples 1-10 are attached on the BGA components. The pad surface of the BGA component is processed to be bare copper, and a reflow profile of 240° C. peak temperature is used to weld. The produced solder balls are welded on the BGA components to form the solder bumps, then the BGA components are welded on the corresponding circuit boards, and the pad surfaces of the circuit board are processed to be organic solderability preservatives (OSPs). Next, he welded circuit board are performed with the thermal cycle test (the test condition is illustrated as follows: the temperature variation range is −40-125° C., the increment and decrement temperature rate is 15° C./min, the duration time is 10 min, and the cycle time is 1000 times). Before the thermal cycle test, resistances of the well welded circuit board samples are measured (i.e. measuring the initial resistances), and after the thermal cycle test is performed, the resistances of the well welded circuit board samples are measured again (i.e. measuring the resistances after testing). The objective is to measure resistances of junction structures of the solder bumps and copper material to thermal fatigue, wherein the solder bumps are formed by the solder balls which are made of the lead-free and copper-free tin alloy in embodiments 1-11 and comparative examples 1-10. If the resistances of junction structure of the solder bumps and copper material to thermal fatigue is not enough large, the welding joint or the junction structure is destroyed by the thermal fatigue caused by the thermal cycle, which affects the reliability of the welding joint.

The measure is to measure the resistances of the circuit board samples after the thermal cycle test is performed, and by comparing the resistance variations after the circuit board samples are performed with the thermal cycle test, the thermal fatigue resistances of the solder bumps and the junction structures are evaluated. The resistance variation is defined as the resistance difference (the resistance after testing subtracts the initial resistance) over the initial resistance. The judge standard is illustrated as follows: if the resistance variation is less than 10%, the thermal fatigue resistance of the solder bump and the junction structure of the alloy is judged to be good denoted with a mark “∘”; if the resistance variation is 10-20%, the thermal fatigue resistance of the solder bump and the junction structure of the alloy is judged to be acceptable denoted with a mark “Δ”; and if the resistance variation is larger than 20%, the thermal fatigue resistance of the solder bump and the junction structure of the alloy is judged to be bad denoted with a mark “X”. The thermal cycle test results of the lead-free and copper-free tin alloy in embodiments 1-11 and comparative examples 1-10 are showed in Table 1.

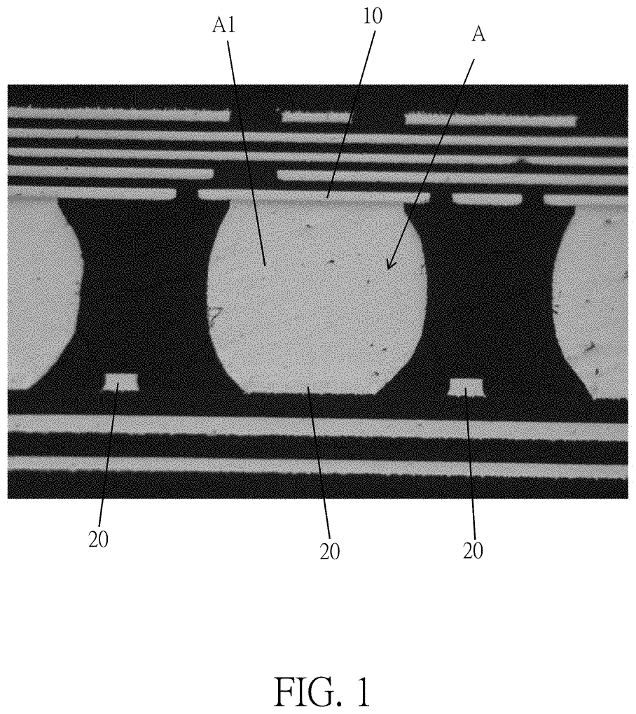

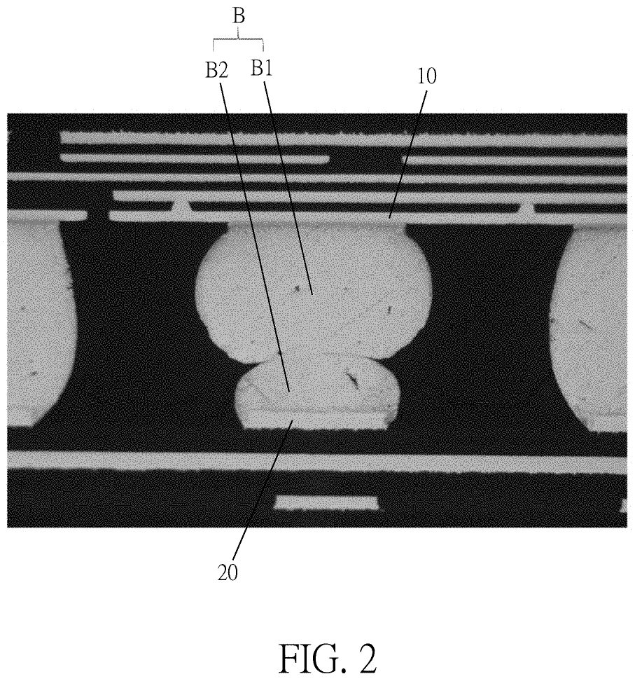

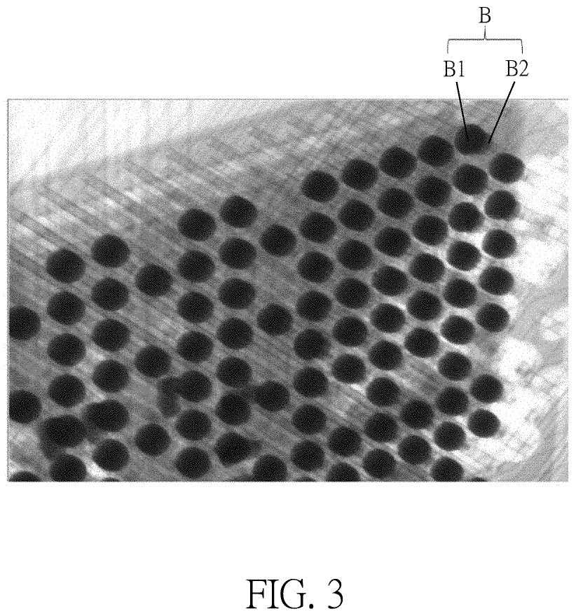

Regarding FIG. 1 through FIG. 3, and such drawings are illustrated as follows. FIG. 1 is a photograph which illustrates a slice of a normal solder bump formed by embodiment 1, wherein a BGA component 10 is disposed on the normal solder bump A, a circuit board 20 is disposed under the normal solder bump A, and the normal solder bump A is a single solder bump μl. FIG. 2 is a photograph which illustrates a slice of a defective solder bump formed by comparative example 9, wherein a BGA component 10 is disposed on the defective solder bump B, a circuit board 20 is disposed under the defective solder bump B, and the defective solder bump B are two separated solder bumps B1 and B2, thus showing the bad welding property. FIG. 3 is a photograph which illustrates an X-ray observation result of a defective solder bump formed by comparative example 9, wherein the defective solder bump B are two separated solder bumps B1 and B2, thus showing the bad welding property.

Further, it is noted that if one of the test results of the ball shear test, the hardness test, the tensile test, the board level soldering test and the thermal cycle test in one embodiment or comparative example is denoted as “X”, the overall assessment in Table 1 is denoted as “X”, which means the embodiment or comparative example does not satisfy the requirement of the present disclosure; if one of the test results of the ball shear test, the hardness test, the tensile test, the board level soldering test and the thermal cycle test in one embodiment or comparative example is denoted as “Δ”, the overall assessment in Table 1 is denoted as “Δ”, which means the embodiment or comparative example satisfies the requirement of the present disclosure; and if all of the test results of the ball shear test, the hardness test, the tensile test, the board level soldering test and the thermal cycle test in one embodiment or comparative example are denoted as “∘”, the overall assessment in Table 1 is denoted as “∘”, which means the embodiment or comparative example is the more optimal embodiment of the present disclosure.

<Alloy Test Results in Properties and Discussion>

The test results of different wt % of silver, different wt % of bismuth, different wt % of antimony, different wt % of nickel and different wt % of germanium are discussed in the following descriptions.

TABLE 2
[different wt % of silver]
(excerpting from Table 1)

| | wt % of metal composition | | | | | | test result in property | | | | | |
|---|---|---|---|---|---|---|---|---|---|---|---|---|
| | Sn | Ag | Bi | Sb | Ni | Ge | P1 | P2 | P3 | P4 | P5 | P6 |
| E1 | res. | 4.0 | 3.0 | 1.0 | 0.05 | 0.01 | ◯ | ◯ | ◯ | ◯ | ◯ | ◯ |
| E2 | res. | 3.0 | 3.0 | 1.0 | 0.05 | 0.01 | ◯ | Δ | ◯ | ◯ | ◯ | Δ |
| E3 | res. | 5.0 | 3.0 | 1.0 | 0.05 | 0.01 | Δ | ◯ | Δ | Δ | Δ | Δ |
| EX1 | res. | 2.0 | 3.0 | 1.0 | 0.05 | 0.01 | ◯ | X | ◯ | X | ◯ | X |
| EX2 | res. | 6.0 | 3.0 | 1.0 | 0.05 | 0.01 | X | ◯ | X | X | X | X |

From Table 2, it can be known that the wt % of the silver affects hardness, the thermal fatigue resistance of the welding joint and junction interface and the oxidization resistance of the alloy. If the oxidization resistance of the solder ball is not enough large, it increases the dual ball defective rate after the ball attached component is performed with the board level soldering process. If the wt % of the silver is too low, the lead-free and copper-free tin alloy cannot pass the harness test and the thermal cycle test. Though the high wt % of the silver can achieve the high hardness, the melting point of the lead-free and copper-free tin alloy is increased and the ductility of the lead-free and copper-free tin alloy is decreased. The increasing of the melting point means the ball attach welding property becomes poor in the same temperature environment, and the lead-free and copper-free tin alloy cannot pass the ball shear test. The decreasing of the ductility means the lead-free and copper-free tin alloy cannot pass the tensile test. Further, the high wt % of the silver makes the lead-free and copper-free tin alloy not pass the thermal cycle test and the board level soldering test.

Comparative example 1 has the 2.0 wt % silver, the hardness test result and the thermal cycle test result are denoted as “X”, and this means the low wt % of the silver (i.e. less than 3.0 wt %) results the poor hardness and poor thermal fatigue of the welding point and the junction interface. Comparative example 2 has the 6.0 wt % silver, the hardness test result is denoted as “∘”, but the test results of the ball shear test, the ensile test, the thermal cycle test, the board level soldering test and the overall assessment are denoted as “X”, which means the high wt % of the silver (i.e. larger than 5.0 wt %) results the poor thermal fatigue of the welding point and the junction interface and the poor oxidization resistance, and makes the lead-free and copper-free tin alloy not pass the ball shear test and the tensile test. Embodiment 2 has the 3.0 wt % silver, embodiment 1 has the 4.0 wt % silver, and the embodiment 3 has the 5.0 wt % silver, the overall assessment in Table 2 are denoted “Δ” or “∘”, which means the 3.0-5.0 wt % silver contained in the lead-free and copper-free tin alloy can meet the requirement of the present disclosure.

TABLE 3
[different wt % of bismuth]
(excerpting from Table 1)

| | wt % of metal composition | | | | | | test result in property | | | | | |
|---|---|---|---|---|---|---|---|---|---|---|---|---|
| | Sn | Ag | Bi | Sb | Ni | Ge | P1 | P2 | P3 | P4 | P5 | P6 |
| E1 | res. | 4.0 | 3.0 | 1.0 | 0.05 | 0.01 | ◯ | ◯ | ◯ | ◯ | ◯ | ◯ |
| E4 | res. | 4.0 | 0.01 | 1.0 | 0.05 | 0.01 | ◯ | Δ | ◯ | Δ | ◯ | Δ |
| E5 | res. | 4.0 | 3.5 | 1.0 | 0.05 | 0.01 | ◯ | ◯ | Δ | ◯ | ◯ | Δ |
| EX3 | res. | 4.0 | 0 | 1.0 | 0.05 | 0.01 | ◯ | X | ◯ | X | ◯ | X |
| EX4 | res. | 4.0 | 4.0 | 1.0 | 0.05 | 0.01 | ◯ | ◯ | X | Δ | ◯ | X |

From Table 3, it can be known that that the wt % of bismuth affects hardness and the thermal fatigue resistance of the welding joint and junction interface of the alloy. If the wt % of the bismuth is too low, the lead-free and copper-free tin alloy cannot pass the harness test and the thermal cycle test. Though the high wt % of the bismuth can achieve the high hardness, the ductility of the lead-free and copper-free tin alloy is decreased, which makes the lead-free and copper-free tin alloy fail to pass the tensile test.

Comparative example 3 has the 0 wt % bismuth, the hardness test result and the thermal cycle test result are denoted as “X”, and this means the low wt % of the bismuth (i.e. less than 0.01 wt %) results the poor hardness and poor thermal fatigue of the welding point and the junction interface. Comparative example 4 has the 4.0 wt % bismuth, the hardness test result is denoted as “∘”, but the test results of the tensile test and the overall assessment are denoted as “X”, which means the high wt % of the bismuth (i.e. larger than 3.5 wt %) makes the lead-free and copper-free tin alloy fail to pass the tensile test. Embodiment 4 has the 0.01 wt % bismuth, embodiment 1 has the 3.0 wt % bismuth, and the embodiment 5 has the 3.5 wt % bismuth, the overall assessment in Table 3 are denoted “Δ” or “∘”, which means the 0.01-3.5 wt % bismuth contained in the lead-free and copper-free tin alloy can meet the requirement of the present disclosure.

TABLE 4
[different wt % of antimony]
(excerpting from Table 1)

| | wt % of metal composition | | | | | | test result in property | | | | | |
|---|---|---|---|---|---|---|---|---|---|---|---|---|
| | Sn | Ag | Bi | Sb | Ni | Ge | P1 | P2 | P3 | P4 | P5 | P6 |
| E1 | res. | 4.0 | 3.0 | 1.0 | 0.05 | 0.01 | ◯ | ◯ | ◯ | ◯ | ◯ | ◯ |
| E6 | res. | 4.0 | 3.0 | 0.01 | 0.05 | 0.01 | ◯ | Δ | ◯ | Δ | ◯ | Δ |
| E7 | res. | 4.0 | 3.0 | 3.50 | 0.05 | 0.01 | Δ | ◯ | Δ | ◯ | Δ | Δ |
| EX5 | res. | 4.0 | 3.0 | 0 | 0.05 | 0.01 | ◯ | X | ◯ | X | ◯ | X |
| EX6 | res. | 4.0 | 3.0 | 4.0 | 0.05 | 0.01 | X | ◯ | X | Δ | X | X |

From Table 4, it can be known that that the wt % of antimony affects hardness and the thermal fatigue resistance of the welding joint and junction interface and the oxidization resistance of the alloy. If the oxidization resistance of the solder ball is not enough large, it increases the dual ball defective rate after the ball attached component is performed with the board level soldering process. If the wt % of the antimony is too low, the lead-free and copper-free tin alloy cannot pass the harness test and the thermal cycle test. Though the high wt % of the antimony can achieve the high hardness, the melting point of the lead-free and copper-free tin alloy is increased and the ductility of the lead-free and copper-free tin alloy is decreased. The increasing of the melting point means the ball attach welding property becomes poor in the same temperature environment, and the lead-free and copper-free tin alloy cannot pass the ball shear test. The decreasing of the ductility means the lead-free and copper-free tin alloy cannot pass the tensile test. Further, the high wt % of the antimony makes the lead-free and copper-free tin alloy not pass and the board level soldering test.

Comparative example 5 has the 0 wt % antimony, the hardness test result and the thermal cycle test result are denoted as “X”, and this means the low wt % of the antimony (i.e. less than 0.01 wt %) results the poor hardness and poor thermal fatigue of the welding point and the junction interface. Comparative example 6 has the 4.0 wt % antimony, the hardness test result is denoted as “∘”, but the test results of the ball shear test, the ensile test, the board level soldering test and the overall assessment are denoted as “X”, which means the high wt % of the antimony (i.e. larger than 3.5 wt %) results the poor oxidization resistance, and makes the lead-free and copper-free tin alloy not pass the ball shear test and the tensile test. Embodiment 6 has the 0.01 wt % antimony, embodiment 1 has the 1.0 wt % antimony, and embodiment 7 has 3.5 wt % antimony, the overall assessment in Table 4 are denoted “Δ” or “∘”, which means the 0.01-3.5 wt % antimony contained in the lead-free and copper-free tin alloy can meet the requirement of the present disclosure.

TABLE 5
[different wt % of nickel]
(excerpting from Table 1)

| | weight percentage of metal (wt %) | | | | | | test results of characteristics | | | | | |
|---|---|---|---|---|---|---|---|---|---|---|---|---|
| | Sn | Ag | Bi | Sb | Ni | Ge | P1 | P2 | P3 | P4 | P5 | P6 |
| E1 | res. | 4.0 | 3.0 | 1.0 | 0.05 | 0.01 | ◯ | ◯ | ◯ | ◯ | ◯ | ◯ |
| E8 | res. | 4.0 | 3.0 | 1.0 | 0.005 | 0.01 | ◯ | ◯ | ◯ | Δ | ◯ | Δ |
| E9 | res. | 4.0 | 3.0 | 1.0 | 0.1 | 0.01 | ◯ | ◯ | Δ | ◯ | ◯ | Δ |
| EX7 | res. | 4.0 | 3.0 | 1.0 | 0 | 0.01 | ◯ | ◯ | ◯ | X | ◯ | X |
| EX8 | res. | 4.0 | 3.0 | 1.0 | 0.2 | 0.01 | ◯ | ◯ | X | Δ | ◯ | X |

From Table 5, it can be known that that the wt % of nickel affects the thermal fatigue resistance of the welding joint and junction interface of the alloy. If the wt % of the nickel is too low, the lead-free and copper-free tin alloy cannot pass the thermal cycle test. Though the high wt % of the nickel can achieve the high thermal fatigue resistance of the welding joint and junction interface, the ductility of the lead-free and copper-free tin alloy is decreased, which makes the lead-free and copper-free tin alloy fail to pass the tensile test.

Comparative example 7 has the 0 wt % nickel, the thermal cycle test result are denoted as “X”, and this means the low wt % of the nickel (i.e. less than 0.005 wt %) results the poor thermal fatigue of the welding point and the junction interface. Comparative example 8 has the 0.2 wt % nickel, the thermal cycle test result is denoted as “∘”, but the test results of the tensile test and the overall assessment are denoted as “X”, which means the high wt % of the nickel (i.e. larger than 0.1 wt %) makes the lead-free and copper-free tin alloy fail to pass the tensile test. Embodiment 8 has the 0.005 wt % nickel, embodiment 1 has the 0.05 wt % nickel, and embodiment 9 has the 0.1 wt % nickel, the overall assessment in Table 5 are denoted “Δ” or “∘”, which means the 0.005-0.1 wt % nickel contained in the lead-free and copper-free tin alloy can meet the requirement of the present disclosure.

TABLE 6
[different wt % of germanium]
(excerpting from Table 1)

| | weight percentage of metal (wt %) | | | | | | test results of characteristics | | | | | |
|---|---|---|---|---|---|---|---|---|---|---|---|---|
| | Sn | Ag | Bi | Sb | Ni | Ge | P1 | P2 | P3 | P4 | P5 | P6 |
| E1 | res. | 4.0 | 3.0 | 1.0 | 0.05 | 0.01 | ◯ | ◯ | ◯ | ◯ | ◯ | ◯ |
| E10 | res. | 4.0 | 3.0 | 1.0 | 0.05 | 0.005 | ◯ | ◯ | ◯ | ◯ | Δ | Δ |
| E11 | res. | 4.0 | 3.0 | 1.0 | 0.05 | 0.02 | Δ | ◯ | ◯ | ◯ | ◯ | Δ |
| EX9 | res. | 4.0 | 3.0 | 1.0 | 0.05 | 0 | ◯ | ◯ | ◯ | Δ | X | X |
| EX10 | res. | 4.0 | 3.0 | 1.0 | 0.05 | 0.05 | X | ◯ | ◯ | Δ | X | X |

From Table 6, it can be known that that the wt % of the germanium affects the oxidization resistance of the alloy. If the oxidization resistance of the solder ball is not enough large, it increases the dual ball defective rate after the ball attached component is performed with the board level soldering process. If the wt % of the germanium is too low, the lead-free and copper-free tin alloy cannot pass the board level soldering test. If the wt % of the germanium is too high, the welding property of the lead-free and copper-free tin alloy will decrease, which makes the lead-free and copper-free tin alloy cannot pass the ball shear test and the board level soldering test.

Comparative example 9 has the 0 wt % germanium, the board level soldering test result are denoted as “X”, and this means the low wt % of the germanium (i.e. less than 0.005 wt %) results the poor oxidization resistance. Comparative example 10 has the 0.05 wt % germanium, the test results of the ball shear test, the board level soldering test and the overall assessment are denoted as “X”, and this means the high wt % of the germanium (i.e. larger than 0.02 wt %) results the poor oxidization resistance, and makes the lead-free and copper-free tin alloy fail to pass the ball shear test. Embodiment 10 has the 0.005 wt % germanium, embodiment 1 has the 0.01 wt % germanium, and embodiment 11 has the 0.02 wt % germanium, the overall assessment in Table 6 are denoted “Δ” or “∘”, which means the 0.005-0.02 wt % germanium contained in the lead-free and copper-free tin alloy can meet the requirement of the present disclosure.

### CONCLUSION

According to the above results and discussion, the overall assessments of the lead-free and copper-free tin alloy in embodiments 1-11 are denoted “Δ” or “∘”, which means they pass the ball shear test, the hardness test, the tensile test, the board level soldering test and the thermal cycle test. The solder balls made of the lead-free and copper-free tin alloy in embodiments 1-11 for BGA packages can form the solder bumps which are able to withstand the thermal stress caused by the temperature change of the electronic component itself or the environment, and has the ability to withstand high mechanical shocks at the same time.

To sum up, the lead-free and copper-free tin alloy comprises the 3.0-5.0 wt % silver, the 0.01-3.5 wt % bismuth, the 0.01-3.5 wt % antimony, the 0.005-0.1 wt % nickel, the 0.005-0.02 wt % germanium and the tin of the residual weight percentage. Thus, the lead-free and copper-free tin alloy can be used to form the solder balls for BGA packages. Further, the solder bumps made of by such solder balls can withstand the thermal stress caused by the temperature change of the electronic component itself or the environment, and has the ability to withstand high mechanical shocks at the same time, such that the objective of the present disclosure can be achieved.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1. A lead-free and copper-free tin alloy with a total weight percentage of 100 wt %, comprising:
3.0-5.0 wt % silver;
0.01-3.5 wt % bismuth;
0.01-3.5 wt % antimony;
0.005-0.1 wt % nickel;
0.005-0.02 wt % germanium; and
tin of a residual weight percentage.

2. The lead-free and copper-free tin alloy of claim 1, wherein the silver is 3.5-4.5 wt %.

3. The lead-free and copper-free tin alloy of claim 1, wherein the bismuth is 2.5-3.5 wt %.

4. The lead-free and copper-free tin alloy of claim 1, wherein the antimony is 0.5-1.5 wt %.

5. The lead-free and copper-free tin alloy of claim 1, wherein the nickel is 0.045-0.055 wt %.

6. The lead-free and copper-free tin alloy of claim 1, wherein the germanium is 0.005-0.015 wt %.

7. A solder ball for a ball grid array package, which is made of by a lead-free and copper-free tin alloy with a weight percentage of 100 wt %, and the lead-free and copper-free tin alloy comprising:
3.0-5.0 wt % silver;
0.01-3.5 wt % bismuth;
0.01-3.5 wt % antimony;
0.005-0.1 wt % nickel;
0.005-0.02 wt % germanium; and
tin of a residual weight percentage.

8. The solder ball for the ball grid array the package of claim 7, wherein the silver is 3.5-4.5 wt %.

9. The solder ball for the ball grid array package of claim 7, wherein the bismuth is 2.5-3.5 wt %.

10. The solder ball for the ball grid array package of claim 7, wherein the antimony is 0.5-1.5 wt %.

11. The solder ball for the ball grid array package of claim 7, wherein the nickel is 0.045-0.055 wt %.

12. The solder ball for the ball grid array package of claim 7, wherein the germanium is 0.005-0.015 wt %.
